(19) United States
(12) Patent Application Publication
(10) Pub. No.: US 2025/0158452 A1
(43) Pub. Date: May 15, 2025

(54) WIRELESS CHARGING DEVICE

(71) Applicants: INVENTEC (PUDONG) TECHNOLOGY CORPORATION, Shanghai (CN); INVENTEC CORPORATION, Taipei City (TW)

(72) Inventors: Guan-Jie JHAO, Taipei City (TW); Ting Kai CHEN, Taipei City (TW); Kuo Cheng LU, Taipei City (TW); Kuo-Tong FANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/592,248

(22) Filed: Feb. 29, 2024

(30) Foreign Application Priority Data
Nov. 9, 2023 (CN) 202311494178.1

(51) Int. Cl. H02J 50/70; H02J 50/00; H02J 50/10; H02J 50/40; H02J 50/80

(52) U.S. Cl. CPC H02J 50/70; H02J 50/005; H02J 50/10; H02J 50/402; H02J 50/80

(57) ABSTRACT

A wireless charging device includes a first substrate, at least one charging coil, a second substrate, a comb filter, at least one thermistor and a controller. The at least one charging coil is disposed on the first substrate. The second substrate is disposed above the at least one charging coil. The comb filter is disposed on the second substrate, and a projected area along a stacking direction at least partially overlaps the at least one charging coil. The at least one thermistor is disposed on the comb filter. The controller is connected to the at least one charging coil and connected to the at least one thermistor through a part of the comb filter.

### CROSS-REFERENCE TO RELATED APPLICATIONS

This non-provisional application claims priority under 35 U.S.C. § 119(a) on Patent Application No(s). 202311494178.1 filed in China on Nov. 9, 2023, the entire contents of which are hereby incorporated by reference.

### BACKGROUND

### 1. Technical Field

This disclosure relates to a wireless charging device.

### 2. Related Art

At present, for an electric car or a traditional car, it has become a trend to incorporate the wireless charging module (WCM) for mobile phones into standard vehicle accessories. The advantage is that there is no need for additional wiring with the mobile phone and the cumbersome action of inserting the plug could be saved. However, since the mobile phone wireless charging module transmits power at the working frequency of 112 to 128 kilohertz (kHz) defined by the Qi standard (default value 127.772 kHz), with the closed and limited space inside the car, many problems such as electromagnetic interference (EMI) will naturally occur.

### SUMMARY

Accordingly, this disclosure provides a wireless charging device.

According to one or more embodiment of this disclosure, a wireless charging device includes a first substrate, at least one charging coil, a second substrate, a comb filter, at least one thermistor and a controller. The at least one charging coil is disposed on the first substrate. The second substrate is disposed above the at least one charging coil. The comb filter is disposed on the second substrate, and a projected area along a stacking direction at least partially overlaps the at least one charging coil. The at least one thermistor is disposed on the comb filter. The controller is connected to the at least one charging coil and connected to the at least one thermistor through a part of the comb filter.

In view of the above description, by disposing a substrate with a comb filter above the charging coil, the wireless charging device of the present disclosure may reduce the electromagnetic interference problem that the charging coil potentially cause to the surrounding environment during charging. The wireless charging device of the present disclosure may detect whether the mobile phone is overheated during charging with a thermistor disposed in the comb filter, and since the thermistor is connected to the controller that receives the signal through part of the comb filter, the overall circuit configuration of the wireless charging device is more concise.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 schematically illustrates a structure of a wireless charging device according to an embodiment of the present disclosure.

FIG. 2 illustrates an implementation of a charging coil disposed on a first substrate of a wireless charging device according to an embodiment of the present disclosure.

FIG. 3 illustrates an implementation of a comb filter disposed on a second substrate of a wireless charging device according to an embodiment of the present disclosure.

FIG. 4 is a schematic diagram of a charging coil disposed on a first substrate of a wireless charging device according to an embodiment of the present disclosure.

FIG. 5 is a schematic diagram of a comb filter disposed on a second substrate of a wireless charging device according to an embodiment of the present disclosure.

FIG. 6 is a local enlarged view of area A in FIG. 5.

FIG. 7 illustrates the corresponding positional relationship between the thermistor and the charging coil of the wireless charging device according to an embodiment of the present disclosure.

FIG. 8 is a plan view of a second substrate of a wireless charging device according to another embodiment of the present disclosure.

FIG. 9 schematically illustrates a structure of a wireless charging device according to still another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

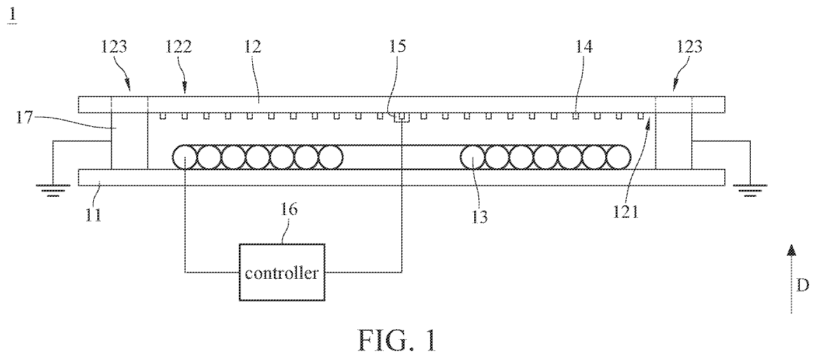

Please refer to FIG. 1 which schematically illustrates a structure of a wireless charging device according to an embodiment of the present disclosure. As shown in FIG. 1, a wireless charging device 1 includes a first substrate 11, a second substrate 12, at least one charging coil 13, a comb filter 14, at least one thermistor 15 and a controller 16. The at least one charging coil 13 is disposed on the first substrate 11. The second substrate 12 is disposed above the at least one charging coil 13. The comb filter 14 is disposed on the second substrate 12, and a projected area along a stacking direction D at least partially overlaps the at least one charging coil 13. The at least one thermistor 15 is disposed on the comb filter 14. The controller 16 is connected to the at least one charging coil 13 and connected to the at least one thermistor 15 through a part of the comb filter 14.

In the present embodiment, the second substrate 12 has a first surface 121, a second surface 122 and a plurality of through holes 123, wherein the first surface 121 faces the charging coil 13. The wireless charging device 1 may further include a plurality of metal connectors 17. The metal connectors 17 are disposed in the plurality of through holes 123, connected to the comb filter 14 and configured for grounding (for example, by connecting to the chassis ground or connecting to a ground wire). The metal connector 17 may also be used as a support member to space the second substrate 12 and the charging coil 13 apart from each other. In addition, although in the wireless charging device 1 described in the present embodiment, the metal connector 17 is used to ground the comb filter 14 and support the second substrate 12, in other embodiments, the comb filter 14 may be grounded through other configurations, and/or the second substrate 12 and the charging coil 13 may be spaced apart from each other through other supports.

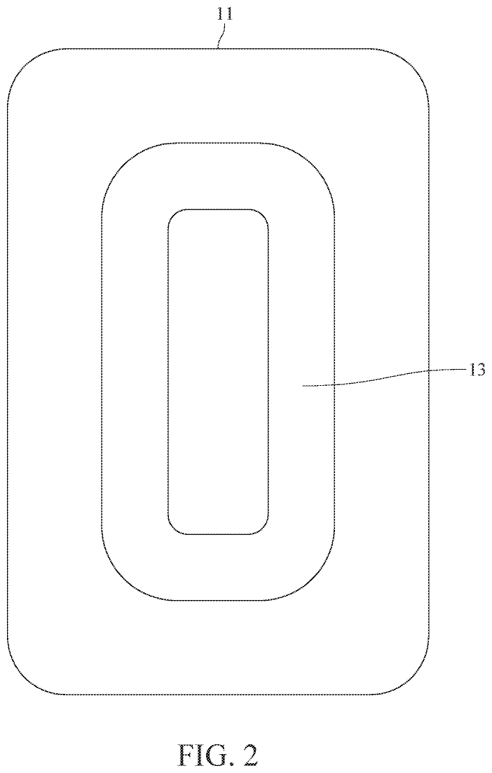

The first substrate 11 may include a layer with shielding capability to prevent the charging coil 13 from causing electromagnetic interference to other electronic devices underneath when operating. Please refer to FIG. 2 which illustrates an implementation of a charging coil disposed on a first substrate of a wireless charging device according to an embodiment of the present disclosure. As shown in FIG. 2, in this implementation, the number of charging coil 13 disposed on the first substrate 11 is one, and the first substrate 11 has a wiring area covered by the charging coil 13 (i.e., an annular area covered by the charging coil 13) and a non-wiring area not covered by the charging coil 13 (i.e., a central area surrounded by the charging coil 13).

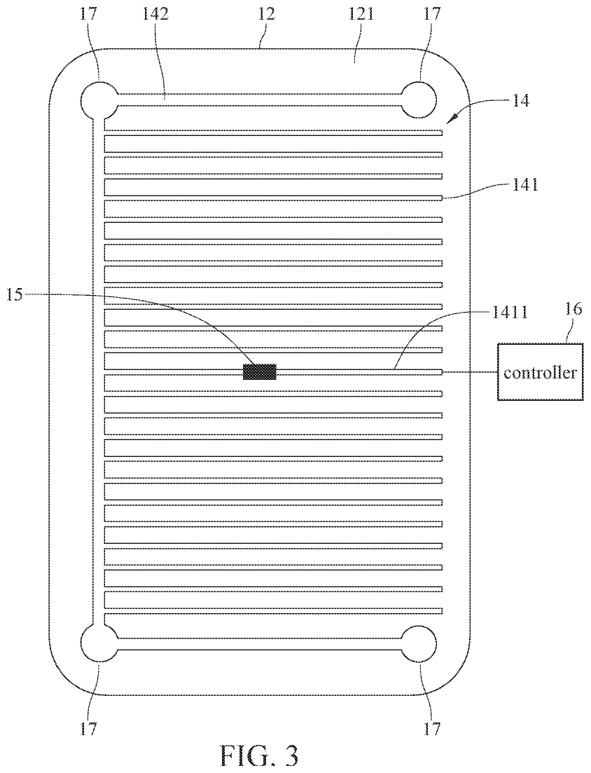

A comb filter 14 is disposed on the first surface 121 of the second substrate 12 facing the charging coil 13. Please refer to FIG. 3 along with FIG. 1 and FIG. 2, FIG. 3 illustrates an implementation of a comb filter disposed on a second substrate of a wireless charging device according to an embodiment of the present disclosure. As shown in FIG. 3, the comb filter 14 includes a comb structure 141 and a ground structure 142. The projected area of the comb structure 141 along the stacking direction D at least partially overlaps the at least one charging coil 13. The ground structure 142 is connected to the comb structure 141 and the metal connectors 17, and is located on the periphery of the comb structure 141. The comb structure 141 includes a plurality of conducting wires, and the thermistor 15 is disposed on one of the conducting wires of the comb structure 141, and the thermistor 15 is preferably disposed above the non-wiring area of the first substrate 11, that is, above the central area surrounded by the charging coil 13.

The thermistor 15 can have corresponding changes in resistance value based on temperature changes of the second substrate 12. The thermistor 15 may have a negative temperature coefficient (NTC) or a positive temperature coefficient (PTC), in which the resistance value of the thermistor with a negative temperature coefficient decreases as the ambient temperature rises, and the resistance value of the thermistor with a positive temperature coefficient increases as the ambient temperature rises. The thermistor 15 described herein is based on a type having a negative temperature coefficient, but the present disclosure is not limited thereto. The controller 16 may have data receiving, recording, computing, storage and output functions, and may include, for example, a microcontroller, a central processing unit, a programmable logic controller, etc. The controller 16 is connected to the thermistor 15 through a connection portion 1411 of the comb structure 141 to read the change in resistance value of the thermistor 15 and obtain the current temperature of the second substrate 12 accordingly. When the controller 16 determines that the current temperature of the second substrate 12 is greater than a preset temperature, which means that the temperature of the device to be charged (mobile phone) is too high, the controller 16 may control the charging coil to reduce the charging power or stop charging.

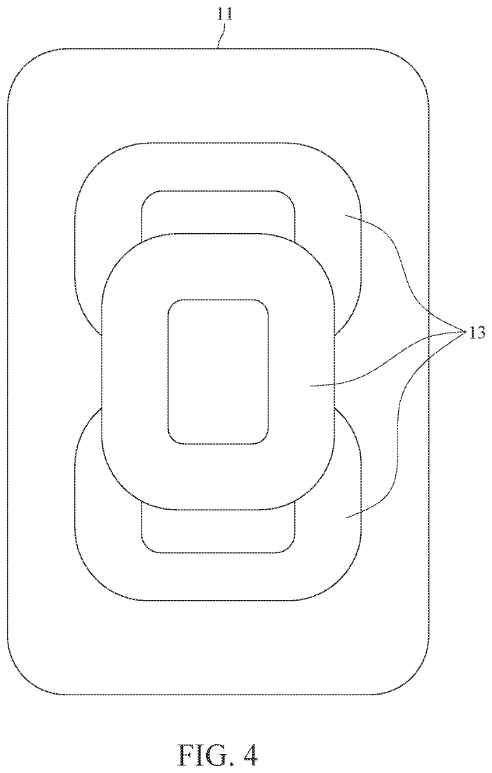

In the present disclosure, the numbers of charging coils and thermistors are not limited, but preferably, the number of thermistors and the number of charging coils may be the same. The number of thermistors and charging coils described in the following example is three. Please refer to FIG. 4 which is a schematic diagram of a charging coil disposed on a first substrate of a wireless charging device according to an embodiment of the present disclosure. As shown in FIG. 4, the number of charging coils 13 disposed on the first substrate 11 is three. The first substrate 11 has a wiring area covered by the charging coil 13 (corresponding to the annular area of the three charging coils 13) and a non-wiring area not covered by the charging coil 13 (corresponding to the area of the three charging coils 13 that do not overlap each other).

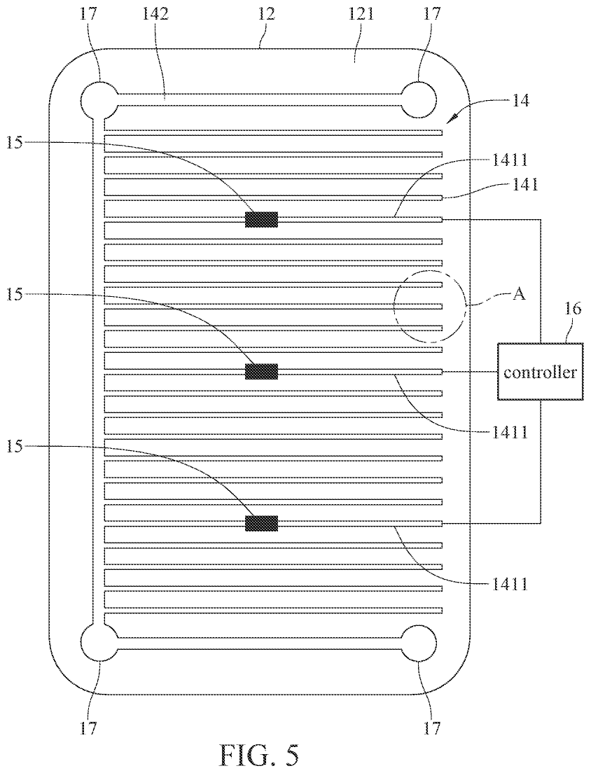

Please refer to FIG. 5 along with FIG. 1 and FIG. 4, FIG. 5 is a schematic diagram of a comb filter disposed on a second substrate of a wireless charging device according to an embodiment of the present disclosure. As shown in FIG. 5, the comb filter 14 includes a comb structure 141 and a ground structure 142. The projected area of the comb structure 141 along the stacking direction D at least partially overlaps the at least one charging coil 13. The ground structure 142 is connected to the comb structure 141 and the metal connectors 17, and is located on the periphery of the comb structure 141. The comb structure 141 includes a plurality of conducting wires, and the three thermistors 15 are respectively disposed on three of the conducting wires of the comb structure 141, and are preferably disposed above the non-wiring area of the first substrate 11, that is, each of the thermistors 15 corresponds to one charging coil 13. The controller 16 is connected to the thermistor 15 through a connection part 1411 of the comb structure 141 to read the resistance value change of each thermistor 15 and obtain the current temperatures of multiple (three) local areas of the second substrate 12 accordingly. When the controller 16 determines that the current temperature of any local areas of the second substrate 12 is greater than a preset temperature, which means that the temperature of the device to be charged (mobile phone) is too high, the controller 16 may control the charging coil to reduce the charging power or stop charging.

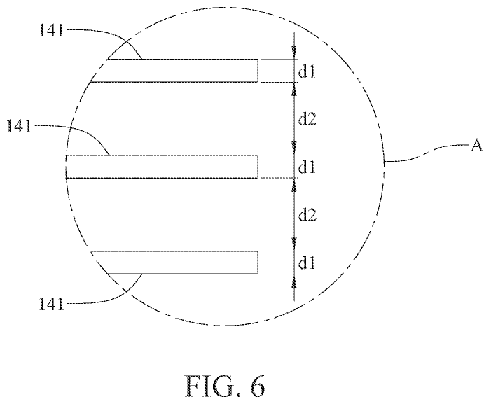

The line width and line spacing of the comb structure 141 described above may be associated with the frequency of the wireless charging signal emitted by the charging coil 13. Please refer to FIG. 6 which is a local enlarged view of area A in FIG. 5. As shown in FIG. 6, The conducting wires of the comb-shaped structure 141 have a line width d1, and there is a line spacing d2 between adjacent conducting wires. The line width d1 and line spacing d2 of the comb structure 141 may be associated with the frequency of the wireless charging signal emitted by the charging coil 13. For example, the line width d1 may be 13 mm, and the line spacing d2 may be 17 mm. Please refer to Table 1 which shows the filtering effects of different line widths d1 and line spacings d2 of the comb structure 141 corresponding to signals of different frequencies.

TABLE 1

| line width/ | | | | | | | | |
|---|---|---|---|---|---|---|---|---|
| line spacing | 0.64 MHz | | 0.85 MHz | | 1.14 MHz | | 1.34 MHz | |
| NA | −6.2 | dB | −3.64 | dB | −9.72 | dB | −8.02 | dB |
| 13 mm/17 mm | −10.64 | dB | −8.34 | dB | −11.12 | dB | −19.77 | dB |
| 10 mm/20 mm | −9.4 | dB | −6.76 | dB | −8.23 | dB | −14.46 | dB |
| 10 mm/15 mm | −10.4 | dB | −10.1 | dB | −17.15 | dB | −12.04 | dB |

As shown in Table 1, the first row corresponds the case where the comb filter is not used (NA). In this case, it has the worst filtering effect for charging signals of various frequencies. The second row corresponds the case where the line width of the comb filter 141 is 13 mm and the line spacing is 17 mm. In this case, it has the best filtering effect for charging signals of 1.34 MHz frequency. The third row corresponds the case where the line width of the comb filter 141 is 10 mm and the line spacing is 20 mm. In this case, the overall filtering effect is slightly lower than the case with the line width/line spacing is 13/17 mm, but it may still perform filtering effectively. The fourth row corresponds the case where the line width of the comb filter 141 is 10 mm and the line spacing is 15 mm. In this case, it has the best filtering effect for charging signals of 0.85 and 1.14 MHz frequencies. Accordingly, the comb filter in the present disclosure can design and adjust the line width and line spacing of the comb structure according to the frequency range of the wireless charging signal in actual applications to optimize the filtering effect. In addition, the test safety standard described above is based on CISPR 25 Class 3.

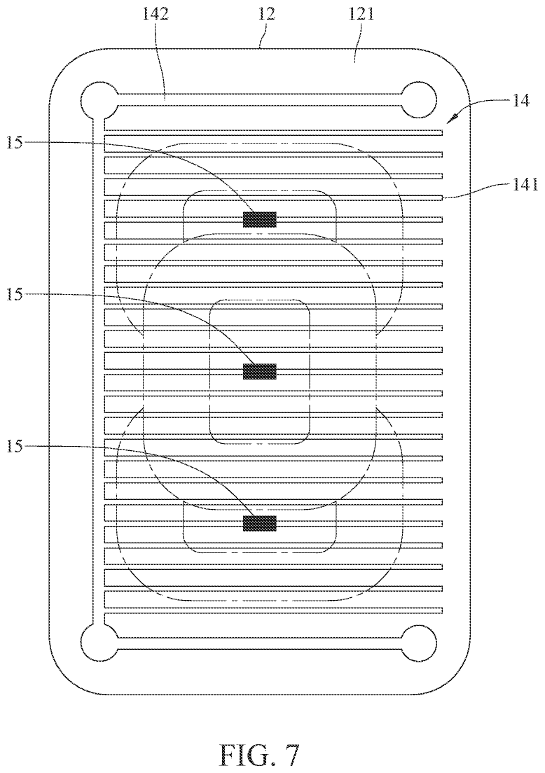

Please refer to FIG. 7 along with FIG. 4 and FIG. 5, FIG. 7 illustrates the corresponding positional relationship between the thermistor and the charging coil of the wireless charging device according to an embodiment of the present disclosure. As shown in FIG. 7, the projection of the three charging coils 13 located on the first substrate 11 projected onto the first surface 121 of the second substrate 12 along the stacking direction described above is completely covered by the comb structure 141 and the ground structure 142 of the comb filter 14. In this way, the comb filter 14 may perform filtering for the charging coil 13 more effectively. Further, three thermistors 15 are disposed above the non-wiring area and respectively above a central area of the first substrate surrounded by each of the three charging coils. It should be noted that the thermistors 15 in this figure are also connected to the controller 16 through a part of the comb structure as shown in FIG. 5, and its repeated description and illustration are omitted herein. Through this configuration, no matter whether the device to be charged (such as a mobile phone) is placed above or below the second substrate 12, the charging coil at the corresponding position may charge it in a wireless way. When the device to be charged is overheated, the thermistor 15 at the corresponding position may more accurately reflect the temperature change by change in resistance value, and allow the controller to obtain the change in resistance value associated with the temperature change.

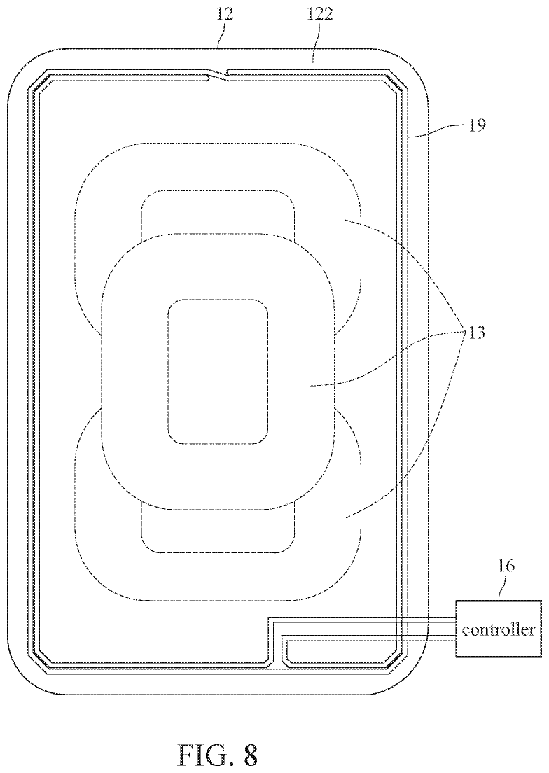

Please refer to FIG. 8 which is a plan view of a second substrate of a wireless charging device according to another embodiment of the present disclosure. In the present embodiment, the wireless charging device may further include a near-field communication antenna 19 disposed on the second surface 122 of the second substrate 12 opposite to the comb filter and connected to the controller 16. As shown in FIG. 8, the projection of the near-field communication antenna 19 downward to the first substrate below is located on the periphery of the three charging coils 13. That is, the projected area of the near-field communication antenna 19 on the first substrate along the stacking direction does not overlap the three charging coils 13. In this way, the wireless charging signal of the charging coil 13 causes less interference on the operation of the near-field communication coil 19. Specifically, the near-field communication coil 19 in this embodiment has a two laps pattern structure, in which the line width is 50 mm and the line spacing is 6 mm. Furthermore, when the near-field communication coil 19 is controlled under an impedance matching condition at 13.56 megahertz (MHz), a card reading distance of more than 5 centimeters for cards with a variety of different near-field communication chips may be achieved, and the controller 16 may obtain the card reading signal.

When the controller 16 obtains the card reading signal, the controller 16 may determine that other cards with near-field communication chips may be placed in the vicinity of the device to be charged (such as a mobile phone). Therefore, the controller 16 may control the charging coil 13 to stop charging to prevent the charging signal from damaging the near-field communication chip on the card. It should be noted that this embodiment may include the application of the previous embodiments. That is, on one hand, the controller 16 may determine whether the current temperature of the second substrate 12 is greater than a preset temperature through the thermistor, and control the charging coil to reduce the charging power or stop charging when the temperature is too high to prevent overheating and damage to the device to be charged; on the other hand, the controller 16 may obtain the card reading signal through the near-field communication coil 19, and when the card reading signal is obtained, the controller 16 controls the charging coil 13 to stop charging to prevent the charging signal from damaging the near-field communication chip on the card.

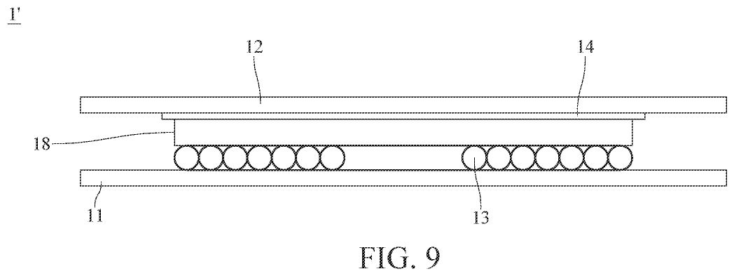

Please refer to FIG. 9 which schematically illustrates a structure of a wireless charging device according to still another embodiment of the present disclosure. As shown in FIG. 9, in the present embodiment, in addition to the first substrate 11, the second substrate 12, the at least one charging coil 13, the comb filter 14, the thermistor and the controller, the wireless charging device 1′ further includes an insulation layer 18 which is disposed between the at least one charging coil 13 and the comb filter 14. Through the arrangement of the insulation layer 18, the second substrate 12 and the comb filter 14 may be supported on the charging coil 13, and the comb filter 14 and the charging coil 13 may be electrically isolated.

In view of the above description, by disposing a substrate with a comb filter above the charging coil, the wireless charging device of the present disclosure may reduce the electromagnetic interference problem that the charging coil potentially cause to the surrounding environment during charging. The wireless charging device of the present disclosure may detect whether the mobile phone is overheated during charging with a thermistor disposed in the comb filter, and since the thermistor is connected to the controller that receives the signal through part of the comb filter, the overall circuit configuration of the wireless charging device is more concise. In addition, by disposing a near-field communication coil on the side of the second substrate opposite to the comb filter, the wireless charging device of the present disclosure may detect whether there are other near-field communication chip cards close to the charging range of the wireless charging coil, to prevent charging signals from damaging the near-field communication chip on the card during the charging process.

In one or more embodiments of the present disclosure, the wireless charging device may be applied to on-board devices of a vehicle, and the vehicle is, for example, autonomous cars, electric cars, or semi-autonomous cars, etc.

What is claimed is:

1. A wireless charging device, comprising:
a first substrate;
at least one charging coil disposed on the first substrate;
a second substrate disposed above the at least one charging coil;
a comb filter disposed on the second substrate, and a projected area along a stacking direction at least partially overlapping the at least one charging coil;
at least one thermistor disposed on the comb filter; and
a controller connected to the at least one charging coil and connected to the at least one thermistor through a part of the comb filter.

2. The wireless charging device of claim 1, wherein the comb filter comprises:
a comb structure with the projected area along the stacking direction at least partially overlapping the at least one charging coil; and
a ground structure connected to the comb structure and located on a periphery of the comb structure.

3. The wireless charging device of claim 2, wherein a line width and a line spacing of the comb structure is associated with a frequency of a wireless charging signal emitted by the at least one charging coil.

4. The wireless charging device of claim 2, wherein the second substrate has a plurality of through holes, and the wireless charging device further comprises:
a plurality of metal connectors disposed in the plurality of through holes, connected to the comb filter and configured for grounding.

5. The wireless charging device of claim 1, wherein the comb filter is disposed on a surface of the second substrate facing the at least one charging coil, the second substrate has a plurality of through holes, and the wireless charging device further comprises:
a plurality of metal connectors disposed in the plurality of through holes and spacing the second substrate and the at least one charging coil apart from each other.

6. The wireless charging device of claim 1, wherein the comb filter is disposed on a surface of the second substrate facing the at least one charging coil, and the wireless charging device further comprises:
an insulating layer disposed between the at least one charging coil and the comb filter.

7. The wireless charging device of claim 1, wherein the first substrate has a wiring area covered by the at least one charging coil and a non-wiring area not covered by the at least one charging coil, and the at least one thermistor is disposed above the non-wiring area.

8. The wireless charging device of claim 1, wherein a number of the at least one thermistor is the same as a number of the at least one charging coil, and each of the at least one thermistor is disposed respectively above a central area surrounded by each of the at least one charging coil.

9. The wireless charging device of claim 1, further comprising:
a near-field communication antenna disposed on a surface of the second substrate opposite to the comb filter and connected to the controller.

10. The wireless charging device of claim 9, wherein a projected area of the near-field communication antenna on the first substrate along the stacking direction does not overlap the at least one charging coil.
